(19) United States
(12) Patent Application Publication
(10) Pub. No.: US 2014/0037947 A1
(43) Pub. Date: Feb. 6, 2014

(54) HOT-MELT ADHESIVE SHEET FOR STACKED POLISHING PAD AND ADHESIVE-LAYER-BEARING SUPPORT LAYER FOR STACKED POLISHING PAD

(71) Applicant: Atsushi Kazuno, Osaka-shi (JP)

(72) Inventor: Atsushi Kazuno, Osaka-shi (JP)

(73) Assignee: TOYO TIRE & RUBBER CO., LTD., Osaka-shi, Osaka (JP)

(21) Appl. No.: 14/111,514

(22) PCT Filed: Apr. 16, 2012
(86) PCT No.: PCT/JP2012/060263

§ 371 Date: Oct. 11, 2013

(30) Foreign Application Priority Data
Apr. 21, 2011 (JP) 2011-095273
Mar. 23, 2012 (JP) 2012-067537

(51) Int. Cl. C09J 7/02

(52) U.S. Cl. CPC C09J 7/0203
USPC 428/349

(57) ABSTRACT

The purpose of the present invention is to provide a hot-melt adhesive sheet for a stacked polishing pad wherein a polishing layer is resistant to detachment from a support layer even when high temperatures are produced by long periods of polishing. This hot-melt adhesive sheet is used to laminate a polishing layer to a support layer, and the hot-melt adhesive is a polyester-based hot-melt adhesive that, for each 100 weight parts of a polyester-resin base polymer, contains 2 to 10 weight parts of an epoxy resin that has at least two glycidyl groups per molecule.

### TECHNICAL FIELD

The invention relates to a hot-melt adhesive sheet and an adhesive-layer-bearing support layer each for use in forming a stacked polishing pad with which materials required to have a high degree of surface flatness, such as optical materials including lenses and reflective mirrors, silicon wafers, substrates for hard discs, aluminum substrates, and general metal materials to be subjected to polishing, can be stably planarized with high polishing efficiency.

### BACKGROUND ART

Production of a semiconductor device involves a step of forming an electroconductive film on the surface of a wafer to form a wiring layer by photolithography, etching etc., a step of forming an interlaminar insulating film on the wiring layer, etc., and an uneven surface made of an electroconductive material such as metal and an insulating material is generated on the surface of a wafer by these steps. In recent years, processing for fine wiring and, multilayer wiring is advancing for the purpose of higher integration of semiconductor integrated and accordingly techniques of planarizing an uneven surface of a wafer have become important.

Conventional polishing pads for use in high-precision polishing are generally produced using a polyurethane resin foam sheet. Unfortunate, such a polyurethane resin foam sheet has insufficient cushioning properties and therefore can hardly apply uniform pressure to the entire surface of as wafer, though it has high local-planarization performance. In general, therefore, a soft cushion layer is additionally provided on the back side of such a polyurethane resin foam sheet, and the resulting laminated polishing pad is used for polishing.

However, conventional laminated polishing pads, which usually have a polishing layer and a cushion layer bonded together with a double-sided tape, have a problem in that a slurry can enter between the polishing, layer and the cushion layer during polishing, so that the durability of the double tape can decrease and delamination can easily occur between the polishing layer and the cushion layer.

Examples of proposed methods to solve this problem include the techniques described below.

Patent Document 1 discloses that a plastic film and a polishing pad are bonded together with a reactive hot-melt adhesive.

Patent Document 2 discloses a polishing pad including a base layer and a polishing layer bonded together with a hot-melt adhesive layer.

Patent Document 3 discloses a technique for forming a polishing pad including a polishing layer and a base layer bonded together with a double-sided tape, wherein a water blocking layer including a hot-melt adhesive is provided between the back side of the polishing layer and the double-sided tape to block a polishing slurry.

Patent Document 4 discloses a polishing pad including a polishing layer and a base layer bonded together with a hot-melt adhesive containing EVA.

Unfortunately, the hot-melt adhesives disclosed in Patent Documents 1 to 4 have a problem in that their heat resistance is low, and at high temperature caused by polishing for a long period of time, their tackiness decreases so that delamination can easily occur between the polishing layer and the cushion layer or the like.

### PRIOR ART DOCUMENTS

### Patent Documents

Patent Document 1: JP-A-200-274944
Patent Document 2: JP-A-2005-167200
Patent Document 3: JP-A-2009-95945
Patent Document 4: JP-A-2010-9296

### SUMMARY OF THE INVENTION

### Problems to be Solved by the Invention

It is an object of the invention to provide a hot-melt adhesive sheet for forming a stacked polishing pad (hereinafter also referred to as a “hot-melt adhesive sheet”) and an adhesive-layer-bearing support layer for forming a stacked polishing pad (hereinafter also referred to as an “adhesive-layer-bearing support layer”) which each make it possible for as stacked polishing pad to resist delamination between a polishing layer and a support layer even at high temperature caused by polishing for a long period of time.

### Means for Solving the Problems

As a result of earnest investigations to solve the problems, the inventors have accomplished the invention based on the finding that the object can be achieved by the hot-melt adhesive sheet or adhesive-layer-bearing support layer shown below.

Specifically, the invention is directed to a hot-melt adhesive sheet for use in laminating a polishing layer and a support layer to form a stacked polishing pad, the hot-melt adhesive sheet including a hot-melt adhesive, wherein the hot-melt adhesive is a polyester-based hot-melt adhesive containing 100 parts by weight of a polyester resin as a base polymer and 2 to 10 parts by weight of an epoxy resin having two or more glycidyl groups per molecule.

If the added amount of the epoxy resin is less than 2 parts by weight, the hot-melt adhesive sheet can have insufficient durability against “shearing,” which occurs during polishing when high temperature is produced by long-time polishing, so that delamination can easily occur between the polishing layer and the support layer. On the other hand, if it is more than 10 parts by weight, the hot-melt adhesive can have too high hardness and thus lower tackiness, so that delamination can easily occur between the polishing layer and the support layer.

The polyester resin as a base polymer is preferably a crystalline polyester resin. When a crystalline polyester resin is used, the hot-melt adhesive sheet will have higher chemical resistance to a slurry and will be less likely to decrease in adhesive strength.

The polyester-based hot-melt adhesive preferably has a melting point of 100 to 200° C. and a specific gravity of 1.1 to 1.3 and also preferably has a melt flow index of 16 to 26 g/10 minutes under the conditions of a temperature of 150° C. and a load of 2.16 kg.

The hot-melt adhesive sheet is preferably a double-sided tape including: a backing whose both sides have been subjected to an adhesion-facilitating treatment; and adhesive layers provided on both sides of the backing, wherein the adhesive layers each include the hot-melt adhesive. The adhesion-facilitating treatment is preferably a corona treatment or a plasma treatment. When both sides of the backing have been subjected to an adhesion-facilitating treatment, good tackiness can be obtained even at high temperature caused by polishing for a long period of time.

The invention is also directed to an adhesive-layer-bearing support layer for a stacked polishing pad, including: a support layer; and an adhesive layer formed on one side of the support layer by applying a polyester-based hot-melt adhesive to one side of the support layer and curing the polyester-based hot-melt adhesive, wherein the polyester-based hot-melt adhesive contains 100 parts by weight of a polyester resin as a base polymer and 2 to 10 parts by weight of en epoxy resin having two or more glycidyl groups per molecule. When the hot-melt adhesive is applied directly onto the support layer and cured, the resulting adhesive-layer-bearing support layer will resist delamination between the support layer and the adhesive layer.

The polyester resin as a base polymer is preferably a crystalline polyester resin. When a crystalline polyester resin is used, the adhesive layer will higher chemical resistance to a slurry and will be less likely to decrease in adhesive strength.

The polyester-based hot-melt adhesive preferably has a melting point of 100 to 200° C. and a specific gravity of 1.1 to 1.3 and also preferably has a melt flow index of 16 to 26 g/10 minutes under the conditions of a temperature of 150° C. and a load of 2.16 kg.

The support layer is preferably a polyurethane foam sheet having a skin layer on the side where the adhesive layer is formed. When a polyurethane foam sheet having a skin layer is used as the support layer, an adhesive layer having uniform thickness and high surface smoothness can be formed on the support layer.

The polyurethane foam sheet is preferably made from thermosetting polyurethane. The hot-melt adhesive is molten at high temperature in the process of applying the hot-melt adhesive onto the support layer. In view of heat resistance, therefore, thermosetting polyurethane is preferably used as a raw material for the support layer.

### Effect of the Invention

The use of the hot-melt adhesive, sheet of the invention or the adhesive-layer-bearing support layer of the invention makes it possible to obtain a stacked polishing pad that has higher hot-melt-adhesive-sheet durability against “shearing” during polishing and resists delamination between a polishing layer and a support layer even at high temperature caused by polishing for a long period of time.

### Mode for Carrying Out the Invention

In the invention, the polishing layer is not restricted as long as it is a foam containing fine cells. For example, the material for the foam may be one of or a blend of two or more of polyurethane resin, polyester resin, polyamide resin, acrylic resin, polycarbonate resin, halogen-containing resin (such as polyvinyl chloride, polytetrafluoroethylene and polyvinylidene fluoride etc.) polystyrene, olefin resin (such as polyethylene and polypropylene etc.), epoxy resin, and photosensitive resin. Polyurethane resin is particularly preferred as a material for forming the polishing layer because polyurethane resin has good wear resistance and because urethane polymers having desired physical properties can be easily obtained through changing the composition of raw materials in various manners. Hereinafter, polyurethane resin will be described as a typical example of the material for the foam.

The polyurethane resin contains an isocyanate component, a polyol component (high-molecular-weight polyol, low-molecular-weight polyol etc.) and a chain extender.

As the isocyanate component, a compound known in the field of polyurethane can be used without particular limitation. The isocyanate component includes, for example, aromatic diisocyanates such as 2,4-toluene diisocyanate, 2,6-toluene diisocyanate, 2,2′-diphenyl methane diisocyanate, 2,4′-diphenyl methane diisocyanate, 4,4′-diphenyl methane diisocyanate, 1,5-naphthalene diisocyanate, p-phenylene diisocyanate, m-phenylene diisocyanate, p-xylylene diisocyanate and m-xylylene diisocyanate, aliphatic diisocyanates such as ethylene diisocyanate, 2,2,4-trimethyl hexamethylene diisocyanate and 1,6-hexamethylene diisocyanate, and cycloaliphatic diisocyanates such as 1,4-cyclohexane diisocyanate, 4,4′-dicyclohexyl methane diisocyanate, isophorone diisocyanate and norbornane diisocyanate. These may be used alone or as a mixture of two or more thereof.

As the high polyol, a compound known in the field of polyurethane can be used without particular limitation. The high-molecular-weight polyol includes, example, polyether polyols represented by polytetramethylene ether glycol and polyethylene glycol, polyester polyols represented by polybutylene adipate, polyester polycarbonate polyols exemplified by reaction products of polyester glycols such as polycaprolactone polyol and polycaprolactone with alkylene carbonate, polyester polycarbonate polyols obtained by reacting ethylene carbonate with a multivalent alcohol and reacting the resulting reaction mixture with an organic dicarboxylic acid, and polycarbonate polyols obtained by ester exchange reaction of a polyhydroxyl compound with aryl carbonate. These may be used singly or as a mixture of two or more thereof.

Besides the above high-molecular-weight polyol described in the above as a polyol component, it is preferred to concomitantly use a low-molecular-weight polyol such as ethyleneglycol, 1,2-propylene glycol, 1,3-propylene glycol, 1,2-butanediol, 1,3-butanediol, 1,4-butanediol, 2,3-butanediol, 1,6-hexanediol, neopentylglycol, 1,4-cyclohexanedimethanol, 3-methyl-1,5-pentanediol, diethyleneglycol, triethyleneglycol, 1,4-bis(2-hydroxyethoxy)benzene, trimethylolpropane, glycerin, 1,2,6-hexanetriol, pentaerythritol, tetramethylol cyclohexane, methylglucoside, sorbitol, mannitol, dulcitol, sucrose, 2,2,6,6-tetrakis(hydroxymethyl)cyclohexanol, diethanolamine, N-methyldiethanolamine and triethanol amine. Low-molecular-weight polyamine such as ethylenediamine, tolylenediamine, diphenylmethanediamine, and diethylenetriamine may be used. Alcohol, amine such as monoethanol amine, 2-(2-aminoethylamino) ethanol and monopropanol amine may be used. These may be used singly or in combination of two or more kinds. The content of the low-molecular-weight polyol, the low-molecular-weight polyamine, or other materials is not particularly limited, and may be appropriately determined depending on the properties required of the polishing pad (polishing layer) to be manufactured.

In the case where a polyurethane resin foam is produced by means of a prepolymer method, a chain extender is used in curing of a prepolymer. A chain extender is an organic compound having at least two active hydrogen groups and examples of the active hydrogen group include: a hydroxyl group, a primary or secondary amino group, a thiol group (SH) and the like. Concrete examples of the chain extender include: polyamines such as 4,4′-methylenebis(o-chloroaniline) (MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-diethyltoluene-2,4-diamine, 3,5-diethyltoluene-2,6-diamine, trimethylene glycol-di-p-aminobenzoate, polytetramethylene oxide-di-p-aminobenzoate, 4,4′-diamino-3,3′,5,5′-tetraethyldiphenylmethane, 4,4′-diamino-3,3′-diisopropyl-5.5′-dimethyldiphenylmethane 4,4′-diamino-3,3′,5,5′-tetraisopropyldiphenylmethane, 1,2-bis(2-aminophenylthio)ethane, 4,4′-diamino-3,3′-diethyl-5.5′-dimethyldiphenylmethane N,N′-di-sec-butyl-4,4′-diaminophenylmethane, 3,3′-diethyl 4,4′-diaminodiphenylmethane, m-xylylenediamine, N,N′-di-sec-butyl-p-phenylenediamine, m-phenylenediamine and p-xylylenediamine, the low-molecular-weight polyol; and the low-molecular-weight polyamine. The chain extenders described above may be used either alone or in mixture of two kinds or more.

A ratio between an isocyanate component, a polyol component and a chain extender in the invention can be altered in various ways according to molecular weights thereof, desired physical properties of a polishing pad and the like. In order to obtain a polishing pad with desired polishing characteristics, a ratio of the number of isocyanate groups in an isocyanate component relative to a total number of arrive hydrogen groups (hydroxyl groups+amino groups) in a polyol component and a chain extender is preferably in the range of from 0.80 to 1.20 and more preferably in the range of from 0.99 to 1.15. When the number of isocyanate groups is outside the aforementioned range, there is a tendons that curing deficiency is caused, required specific gravity and hardness are not obtained, and polishing property is deteriorated.

A polyurethane resin foam can be produced by applying a melting method, a solution method or a known polymerization technique, among which preferable is a melting method, consideration being given to a cost, a working environment and the like.

Manufacture of a polyurethane resin foam is enabled by means of either a prepolymer method or a one shot method, of which preferable is a prepolymer method in which an isocyanate-terminated prepolymer is synthesized from an isocyanate component and a polyol component in advance, with which a chain extender is reacted since physical properties of an obtained polyurethane resin is excellent.

Manufacturing methods of a polyurethane resin foam include: a method in which hollow beads are added, a mechanical foaming method, a chemical foaming method and the like.

Particularly, preferred is a mechanical foaming method using a silicone-based surfactant which is a copolymer of polyalkylsiloxane and polyether and has no an active hydrogen group.

A stabilizer such as antioxidant, a lubricant, a pigment, a filler, an antistatic agent and other additives may be added, as needed.

The polyurethane resin foam may be of a closed cell type or an open cell type.

Production of the polyurethane resin foam may be in a batch system where each component is weighed out, introduced into as vessel and mixed or in a continuous production system where each component and a non-reactive as are continuously supplied to, and stirred in, stirring apparatus and the resulting forming reaction liquid is transferred to produce molded articles.

A manufacturing method of a polyurethane resin foam may be performed in ways: in one of which a prepolymer which is a raw material from which a polyurethane foam is made is put into a reactor, thereafter a chain extender is mixed into the prepolymer, the mixture is agitated, thereafter the mixture is cast into a mold with a predetermined size to thereby prepare a block and the block is sliced with a slicer like a planer or a band saw; and in another of which in the step of casting into the mold, a thin sheet may be directly produced. Besides, a still another way may be adopted in which a resin of raw material is melted, the melt is extruded through a T die to thereby mold a polyurethane resin foam directly in the shape of a sheet.

An average cell diameter of a polyurethane resin foam is preferably in the range of from 30 to 80 μm and more preferably the range of from 35 to 60 μm. If an average cell diameter falls outside the range, a tendency arises that a polishing rate is decreased and a planarity of an object to be polished (a wafer) after polishing is reduced.

Preferably, the polyurethane resin foam has a specific gravity ranging from 0.5 to 1.3. When the specific gravity is less than 0.5, the surface strength of the polishing layer decreases, so that the planarity of the object to be polished tends to decrease. When the specific gravity is larger than 1.3, the cell number on the surface of the polishing layer decreases, so that the polishing rate tends to decrease despite excellent planarity.

Preferably, the polyurethane resin foam has a hardness measured by ASKER D hardness meter, ranging from 40 to 75 degrees. When the ASKER D hardness is less than 40 degrees, the planarity of the object to be polished decreases while when the hardness is more than 75 degrees, the uniformity of the object to be polished tends to decrease despite excellent planarity.

Preferably, a polishing surface of the polishing layer, which comes into contact with an object to be polished have a asperity structure provided for retaining and refreshing a slurry. A polishing layer made of a foam has a number of openings in the polishing surface, and has a function of retaining and refreshing a slurry. By forming an asperity structure on the polishing surface, it is possible to conduct retention and refreshment of the slurry more efficiently, and to prevent the object to be polished from breaking due to adsorption of the material to be polished. The shape of the asperity structure is not particularly limited insofar as it is able to retain and refresh a slurry, and for example, XY grating groove, concentric ring groove, through-hole, non-through-hole, polygonal column, circular cylinder, spiral groove, eccentric ring groove, radial groove, and combination thereof can be recited. These asperity structures generally have regularity, however, groove pitch, groove width, groove depth and the like may be varied by a certain range for achieving desired retention and refreshment of slurry.

The polishing layer may have any shape such as a circular shape or an elongated shape. The size of the polishing layer may be appropriately adjusted depending on the polishing apparatus to be used. When the polishing layer is circular, it may have a diameter of about 30 to about 150 cm, and when the polishing layer has an elongated shape, it may have a length of about 5 to about 15 m and a width of about 60 to about 250 cm.

The thickness of the polishing layer is generally, but is not limited, to, about 0.8 to 4 mm, and preferably 1.2 to 2.5 mm.

The polishing layer may be provided with a transparent member for use in optically detecting an end point during polishing. The transparent member can be fixed by being fit in an opening formed in the polishing layer and being bonded to the hot-melt adhesive she under the polishing layer.

The stacked polishing pad is made by bonding the polishing layer and the support layer together with the hot-melt adhesive sheet.

The support layer is provided to supplement the characteristics of the polishing layer. The support layer to be used may be a layer (cushion layer) having an elastic modulus lower than that of the polishing layer or may be a layer (high modulus layer) having an elastic modulus higher than that of the polishing layer. The cushion layer is necessary for CMP to achieve both good planarity and good uniformity, which are usually in a trade-off relationship. The term “planarity” refers to the flatness of a patterned part formed by polishing an object to be polished having fine irregularities, which are produced in a patterning process. The term “uniformity” refers to the entire uniformity of an obi cot to be polished. The characteristics of the polishing layer contribute to an improvement in planarity, and the characteristics of the cushion layer contribute to an improvement in uniformity. The high modulus layer is used to improve the planarizing characteristics of the polishing pad when a relatively soft polishing layer is use in order to suppress scratching in CMP. The use of the high modulus layer makes it possible to suppress excessive polishing of the edge of an object to be polished.

The thickness of the support layer is preferably, but not limited, to, 0.4 to 2 mm, more preferably 0.6 to 1.5 mm, even more preferably 0.7 mm to 1.3 mm.

Examples of the cushion layer include nonwoven fiber fabrics such as polyester nonwoven fabrics, nylon nonwoven fabrics, and acrylic nonwoven fabrics; resin impregnated nonwoven fabrics such as polyurethane impregnated polyester nonwoven fabrics; polymeric resin foams such as polyurethane foams and polyethylene foams; rubber resins such butadiene rubber and isoprene rubber and photosensitive resins, etc.

Examples of the high modulus layer include polyester firms such as polyethylene terephthalate films and polyethylene naphthalate films; polyolefin films such as polyethylene films and polypropylene films; and nylon films, etc.

When a transparent member is placed in the polishing layer, an opening for transmitting light is preferably formed in the support layer.

The hot-melt adhesive sheet may be an adhesive layer made of a hot-melt adhesive or may be a double-sided tape including a backing and such adhesive, layers provided on both sides of the backing.

A polyester-based hot-melt adhesive is used to make the adhesive lever or layers. The polyester-based hot-melt adhesive contains 100 parts by weight of a polyester resin as a base polymer and 2 to 10 parts by weight of an epoxy resin having two or more glycidyl groups per molecule.

The polyester resin may be any known polyester resin which is obtained by condensation polymerization of an acid and a polyol or the polymerization processes. In particular, the polyester resin is preferably a crystalline polyester resin.

Examples of the acid include aromatic dicarboxylic aliphatic dicarboxylic acids, and alicyclic dicarboxylic acids, etc. These may be used alone or in combination of two or more.

Examples of aromatic dicarboxylic acids include terephthalic acid, isophthalic acid, phthalic anhydride, α-naphthalene dicarboxylic acid, β-naphthalene dicarboxylic acid, and their ester forms, etc.

Examples of aliphatic dicarboxylic acids include succinic acid, glutaric acid, adipic acid, pimelic acid, suberic acid, azelaic acid, sebacic acid, undecylenic acid, dodecanedioic acid, and their ester forms, etc.

Examples of alicyclic dicarboxylic acids include 1,4-cyclohexane dicarboxylic acid, tetrahydrophthalic anhydride, hexahydrophthalic anhydride, etc.

An unsaturated acid such as maleic acid, fumaric acid, or dimer acid, a polycarboxylic acid such as trimellitic acid or pyromellitic acid, or other acids may also be used as the acid in combination with any of the above acids.

Examples of the polyol include dihydric alcohols such as aliphatic glycols and alicyclic glycols, and polyhydric alcohols. These may be used alone or in combination of two or more.

Examples of aliphatic glycols include, ethylene glycol, 1,2-propylene glycol, 1,3-propylene glycol, 1,3-butanediol, 1,4-butanediol, 1,5-pentanediol, 1,6-hexanediol, 1,8-octanediol, 1,9-nonanediol, neopentyl glycol, 3-methylpentanediol, 2,2,3-trimethylpentanediol, diethylene glycol, triethylene glycol, dipropylene glycol, etc.

Examples of alicyclic glycols include 1,4-cyclohexanedimethanol, hydrogenated bisphenol A, etc.

Examples of polyhydric alcohols include glycerin, trimethylolethane, trimethylolpropane, pentaerythritol, etc.

The crystalline polyester resin can be synthesized by known methods. Examples include melt polymerization methods including adding raw materials and a catalyst and heating the mixture at a temperature equal to or higher than the melting point of the desired product, solid-phase polymerization methods including performing polymerization at a temperature equal to or lower than the melting point of the desired product, and solution polymerization methods using a solvent, etc. Any of these methods may be used.

The crystalline polyester resin preferably has a melting point of 100 to 200° C. If the melting point is lower than 100° C., the adhesive strength of the hot-melt adhesive can be lowered by heat generated during polishing. If the melting point is higher than 200° C., a higher temperature will be needed to melt the hot-melt adhesive, which may warp the stacked polishing pad and tend to have an adverse effect on the polishing characteristics.

The crystalline polyester resin preferably has a number average molecular weight of 5,000 to 50,000. If the number average molecular weight is less than 5,000, the boll-melt adhesive may have lower mechanical characteristics, so that as sufficient level of tackiness and durability may fail to be obtained. If the number average molecular weight is more than 50,000, a production failure such as gelation may occur in the process of synthesizing the crystalline polyester resin, or the hot-melt adhesive may tend to have lower performance.

Examples of the epoxy resin include aromatic epoxy resins such as bisphenol A type epoxy resins, brominated bisphenol A type epoxy resins, bisphenol F type epoxy resins, bisphenol AD type epoxy resins, stilbene type epoxy resins, biphenyl type epoxy resins, bisphenol A novolac type epoxy resins, cresol novolac type epoxy resins, diaminodiphenylmethane type epoxy resins, and polyphenyl-based epoxy resins such as tetrakis(hydroxyphenyl)ethane-based epoxy resins fluorene-containing epoxy resins, and epoxy resins containing a triglycidyl isocyanurate moiety or a heteroaromatic ring (such as a triazine ring); and non-aromatic epoxy resins such as aliphatic glycidyl ether type epoxy resins, aliphatic glycidyl ester type epoxy resins, alicyclic glycidyl ether type epoxy resins, and alicyclic glycidyl ester type epoxy resins. These may be used alone or in combination of two or more.

Among them, cresol novolac type epoxy resins are preferably used in view of tackiness to the polishing layer during polishing.

The epoxy resin is necessarily added in an amount of 2 to 10 parts by weight, preferably in an amount of 3 to 7 parts by weight, to 100 parts by weight of the polyester resin as a base polymer.

The polyester-based hot-melt adhesive may also contain known additives such as a softener such as an olefin resin, a tackifier, a filler, a stabilizer, and a coupling agent. The adhesive may also contain a known inorganic filler such as talc and other materials.

The polyester-based hot-melt adhesive can be prepared by mixing at least the polyester resin and the enoxy resin and optional materials by any method. For example, the polyester-based, hot-melt adhesive can be prepared by mixing the respective raw materials using an extruder such as a mono-screw extruder, a co-rotating intermeshing parallel twin screw extruder, a counter-rotating intermeshing parallel twin screw extruder, a counter-rotating intermeshing inclined twin screw extruder, a non-intermeshing twin screw extruder, an incompletely intermeshing twin screw extruder, a co-kneader extruder, a planetary gear extruder, a transfer mixing extruder, a ram extruder, or a roller extruder, or a kneader, etc.

The polyester-based hot-melt adhesive preferably has a melting point of 100 to 200° C.

The polyester-based hot-melt adhesive preferably has a specific gravity of 1.1 to 1.3.

The polyester-based hot-melt adhesive preferably has a melt flow index of 16 to 26 g/10 minutes under the conditions of 150° C. and a load of 2.16 kg.

The polishing layer and the support layer may be bonded together by any method for example, the polishing layer and the support layer may be bonded together by a method including placing a hot-melt adhesive sheet on the support layer (or the polishing layer), melting the adhesive by heat from a heater, and then press-laminating the polishing layer (or the support layer) onto the molten adhesive. The pressing pressure is typically, but not limited to, about 0.1 to about 1.0 MPa.

The adhesive layer made of the hot-melt adhesive preferably has a thickness of 10 to 200 μm, more preferably 30 to 100 μm. If the adhesive layer has a thickness of less than 10 μm, the hot-melt adhesive sheet may have insufficient durability against “shearing,” which occurs during polishing when high temperature is produced by long-time polishing, so that delamination may easily occur between the polishing layer and the support layer. If the adhesive layer has a thickness of more than 200 μm, the transparency may decrease, so that the accuracy of detection of the stacked polishing pad may degrade when the stacked polishing pad has a transparent member for use in optically detecting an end point.

A double-sided tape including a backing and the adhesive layers provided on both sides of the backing may also be used instead of the adhesive layer made of the hot-melt adhesive. The backing can prevent a slurry from permeating to the support layer side, so that delamination between the support layer and the adhesive layer can be prevented.

Examples of the backing include polyester films such as polyethylene terephthalate films and polyethylene naphthalate films; polyolefin films such as polyethylene films and polypropylene films; and nylon films, etc. Among them, polyester films are preferably used, which have high ability to prevent water permeation.

The surface of the backing may be subjected to an adhesion-facilitating treatment such as a corona treatment or a plasma treatment.

The thickness of the backing is preferably, but not limited to, 10 to 100 μm in view of transparency, flexibility, stiffness, and other properties.

When the double-sided tape is used, the thickness of the adhesive layer is preferably from 10 to 200 μm, more preferably from 30 to 100 μm.

Alternatively, the stacked polishing pad may be made bonding the polishing layer and an adhesive-layer-bearing support layer together.

The adhesive-layer-bearing support layer can be made by a process including applying the polyester-based hot-melt adhesive to one side of the support layer and curing the adhesive to form an adhesive layer directly on the support layer. The support layer to be used is preferably a polyurethane foam sheet having a skin layer on the side where the adhesive layer is to be formed. The polyurethane foam sheet is preferably made from thermosetting polyurethane. For the same reason as stated above, the thickness of the adhesive layer is preferably from 10 to 200 μm more preferably from 30 to 100 μm.

The polishing layer and the adhesive-layer-bearing support layer may be bonded together by any method. For example, the polishing layer and the adhesive-layer-bearing support layer may be bonded by a method including melting the adhesive layer of the adhesive-layer-bearing support layer by heat from a heater and then press-laminating the polishing layer onto the molten adhesive layer. The pressing pressure is typically, but not limited to, about 0.1 to about 1.0 MPa.

The stacked polishing pad may also be provided with a double-sided tape on its side to be attached to a platen.

### EXAMPLES

Description will be given of the invention with examples, while the invention is not limited to description in the examples.

[Methods for Measurement and Evaluation]

(Measurement of Number Average Molecular Weight)

The number average molecular weight was measured as a polystyrene-equivalent value by GPC permeation chromatography) with standard polystyrene.

GPC system: LC-10A manufactured by Shimadzu Corporation
Columns: three columns PLgel (5 μm, 500 Å), PLgel (5 μm, 100 Å) and PLgel (5 μm, 50 Å) each manufactured by Polymer Laboratories were coupled and used.
Flow rate: 1.0 ml/minute

### Concentration: 1.0 g/l

Injection volume: 40 μl
Column temperature: 40° C.
Eluent: tetrahydrofuran.

(Measurement of Melting Point)

The melting point of the polyester-based hot-melt adhesive was measured at a rate of temperature rise of 20° C./minute using TOLEDO DSC822 (manufactured by Mettler-Toledo International Inc.).

(Measurement of Specific Gravity)

The measurement was performed according to JIS Z 8807-1976, A 4 cm×8.5 cm adhesive layer strip (of arbitrary thickness) was cut from the polyester-based hot-melt adhesive and used as a sample for the specific gravity measurement. The sample was allowed to stand in an environment at a temperature of 23° C.±2° C. and a humidity of 50%±5% for 16 hours. The sample was measured for specific gravity using a specific gravity meter (manufactured by Sartorius AG).

(Measurement of Melt Flow Index (MT))

The melt flow index of the polyester-based hot-melt adhesive was measured according to ASTM-D1238 under the conditions of 150° C. and 2.16 kg.

(Measurement of Adhesive Strength)

Three, 200 mm long, 25 mm wide, sample pieces were cut from the prepared laminated polishing pad. The adhesive strength (N/25 mm) between the polishing layer and the support layer of each sample was measured at a pulling angle of 180° and a pulling rate of 300 ram/minute. Table 1 shows the average of the measurements for the three samples. In the measurement, the samples were also observed for the state of peeling. A polishing slurry was prepared by adding hydrogen peroxide water to a slurry (W2000 manufactured by Cabot Corporation) so that a concentration of 4% by weight was obtained. The sample was immersed for 8 hours in the polishing slurry adjusted to 80° C., and the adhesive strength was measured by the same method as described above, while the state of peeling was observed. This procedure was repeated five times.

### Production Example 1

To a vessel were added 1,229 parts by weight of toluene diisocyanate (a mixture of 2,4-diisocyanate/2,6-diisocyanate=80/20), 272 parts by weight of 4,4′-dicyclohexylmethane diisocyanate, 1,901 parts by weight of polytetramethylene ether glycol with a number average molecular weight of 1,018, and 198 parts by weight of diethylene glycol, and allowed to react at 70° C. for 4 hours, so that an isocyanate-terminated prepolymer was obtained.

To a polymerization vessel were added 100 parts by weight of the prepolymer and 3 parts by weight of a silicone surfactant (SH-192 manufactured by Dow Corning Toray Co., Ltd.) and mixed. The mixture was adjusted to 80° C. and degassed under reduced pressure. Subsequently, the reaction system was vigorously stirred for about 4 minutes with a stirring blade at a rotational speed of 900 rpm so that air bubbles were incorporated into the reaction system. Thereto was added 21 parts by weight of Ethacure 300 (a mixture of 3,5-bis(methylthio)-2,6-toluenediamine and 3,5-bis(methylthio)-toluenediamine, manufactured by Albemarle Corporation), whose temperature was adjusted to 70° C. in advance. The liquid mixture was stirred for about 1 minute and then poured into a pan-shaped open mold (casting vessel). At the point when the liquid mixture lost its fluidity, it was placed in an oven, and subjected to post curing at 100° C. for 16 hours, so that a polyurethane resin foam block was obtained.

While heated at about 80° C., the polyurethane resin foam block was sliced using a slicer (VGW-125 manufactured by AMITEC Corporation), so that a polyurethane resin foam sheet (50 μm in average cell diameter, 0.86 in specific gravity, and 52 degrees in hardness) was obtained. Subsequently, the surface of the sheet was buffed using a buffing machine (manufactured by AMITEC Corporation) until its thickness reached 2 mm, so that a sheet with regulated thickness accuracy was obtained. The buffed sheet was stamped into a piece with a diameter of 60 cm. Concentric circular grooves with a width 0.25 mm, a pitch of 1.5 mm, and a depth of 0.6 mm were formed on the surface of the piece using a grooving machine (manufactured by Techno Corporation), so that a polishing layer was obtained.

### Example 1

An adhesive layer (50 μm in thickness) was formed on a 50 μm thick PET film (E5200 manufactured by TOYOBO CO., LTD.) whose both sides had been corona-treated. The adhesive layer was made of a polyester-based hot-melt adhesive containing 100 parts by weight of a crystalline polyester resin (VYLON GM420 manufactured by TOYOBO CO., LTD.) and 5 parts by weight of an o-cresal novolac type epoxy resin (EOCN 4400 manufactured by Nippon Kayaku Co., Ltd.) having at least two glycidyl groups per molecule. The surface of the adhesive layer was heated to 150° C. using an infrared heater so that the adhesive layer was molten. Subsequently, using a laminator at a pressure of 0.6 MPa, the polishing layer prepared in Production Example 1 was laminated and pressure-bonded at a feed rate of 1 m/minute onto the molten adhesive layer, so that a laminated product A (polishing layer/adhesive layer/PET film) was obtained.

The same adhesive layer (50 μm in thickness) was formed on a release film, and the surface of the adhesive layer was heated to 150° C. using an infrared heater, so that the adhesive layer was molten. Subsequently, using a laminator at a pressure of 0.6 MPa, the laminated product A and a support layer made of a urethane foam (NIPPALAY EXT manufactured by NHK SPRING Co., Ltd.) were laminated and pressure-bonded at a feed rate of 1 m/minute onto the molten adhesive layer, while the release film was peeled off, so that a laminate product B (polishing layer/adhesive layer/PET film/adhesive layer/Support lave was obtained.

Subsequently, a double-sided pressure-sensitive adhesive tape (442JA manufactured by 3M Company) was bonded to the support layer of the laminated product B using a laminator, so that a stacked polishing pad was obtained.

The polyester-based hot-melt adhesive had a melting point of 142° C., a specific gravity of 1.22, and a melt flow index of 21 g/10 minutes.

### Example 2

An adhesive, layer (50 μm in thickness) was formed on a 50 μm thick PEN film (Teonex Q83 manufactured by Teijin DuPont Films Japan Limited) whose both sides had been corona-treated. The adhesive layer was made of the polyester-based hot-melt adhesive shown in Example 1. Subsequently, a stacked polishing pad was prepared using the same process as in Example 1.

### Example 3

A stacked polishing pad was prepared using the same process as in Example 1, except that a polyester-based hot-melt adhesive containing 100 parts by weight of a crystalline polyester resin (VYLON GM420 manufactured by TOYOBO CO., LTD.) and 2 parts by weight of an o-cresol novolac type epoxy resin (EOCN 4400 manufactured by Nippon Kayaku Co., Ltd.) having at least two glycidyl groups per molecule was used instead. The polyester-based hot-melt adhesive had a melting point of 140° C., a specific gravity of 1.24, and a melt flow index of 26 g/10 minutes.

### Example 4

A stacked polishing pad was prepared using the same process as in Example 1, except that a polyester-based hot-melt adhesive containing 100 parts by weight of a crystalline polyester resin (VYLON GM420 manufactured by TOYOBO CO., LTD.) and 10 parts by weight of an o-cresol novolac type epoxy resin (EOCN 4400 manufactured by Nippon Kayaku Co. Ltd.) having at least two glycidyl groups per molecule was used instead. The polyester-based hot-melt adhesive had a melting point of 145° C., a specific gravity of 1.19, and a melt flow index of 16 g/10 minutes.

### Example 5

Used was a thermosetting polyurethane foam sheet having a skin layer on one side (NIPPALAY EXT, 0.8 mm in thickness, manufactured by NHK SPRING Co., Ltd.). A polyester-based hot-melt adhesive containing 100 parts by weight of a crystalline polyester resin (VYLON GM420 manufactured by TOYOBO CO., LTD.) and 5 parts by weight of an o-cresol novolac type epoxy resin (EOCN 4400 manufactured by Nippon Kayak Co., Ltd.) having at least two glycidyl groups per molecule was applied to the skin layer of the thermosetting polyurethane foam sheet and cured to form an adhesive layer (75 μm in thickness), so that an adhesive-layer-bearing foam sheet was obtained.

The adhesive layer surface of the adhesive-layer-bearing foam sheet was heated to 150° C. using an infrared heater, so that the adhesive layer was molten. Subsequently, using a laminator at a pressure of 0.6 MPa, the polishing layer prepared in Production Example 1 was laminated and pressure-bonded at a feed rate of 0.8 m/minute onto the molten adhesive layer, so that a laminated product (polishing layer/adhesive layer/foam sheet) was obtained.

Subsequently, a double-sided pressure-sensitive adhesive tape (442JA manufactured by 3M Company) was bonded to the foam sheet of the laminated product using a laminator, so that a stacked polishing pad was obtained.

The polyester-based hot-melt adhesive had a melting point of 142° C., a specific gravity of 1.22, and a melt flow index of 21 g/10 minutes.

### Comparative Example 1

A stacked polishing pad was prepared using the same process as in Example 1, except that a polyester-based hot-melt adhesive containing 100 parts by weight of a crystalline polyester resin (VYLON GM420 manufactured by TOYOBO CO., LTD.) and 1 parts by weight of an o-cresol novolac type epoxy resin (EOCN 4400 manufactured by Nippon Kayaku Co., Ltd.) having at least two glycidyl groups per molecule was used instead. The polyester-based hot-melt adhesive had a melting point of 139° C. a specific gravity of 1.25, and a melt flow index of 29 g/10 minutes.

### Comparative Example 2

A stacked polishing pad was prepared using the same process as in Example 1, except that a polyester-based hot-melt adhesive containing 100 parts by weight of a crystalline polyester resin (VYLON GM420 manufactured by TOYOBO CO., LTD.) and 18 parts by weight of an O-cresol novolac type epoxy resin (EOCN 4400 manufactured by Nippon Kayaku Co., Ltd.) having at least two glycidyl groups per molecule, was used instead. The polyester-based hot-melt adhesive had a melting point of 147° C. a specific gravity of 1.18, and a melt flow index of 15 g/10 minutes.

TABLE 1

| | | | | | | | Comparative | Comparative |
|---|---|---|---|---|---|---|---|---|
| | | Example 1 | Example 2 | Example 3 | Example 4 | Example 5 | Example 1 | Example 2 |
| Added amount of epoxy | | 5 | 5 | 2 | 10 | 5 | 1 | 18 |
| resin (parts by weight) | | | | | | | | |
| Backing | | PET | PEN | PET | PET | — | PET | PET |
| Adhesive | Initial | 115 | 125 | 102 | 111 | 120 | 75 | 58 |
| strength | | Material | Material | Material | Material | Material | Interfacial | Interfacial |
| (N/25 mm) | | breaking | breaking | breaking | breaking | breaking | peeling | peeling |
| | After first | 107 | 118 | 95 | 103 | 115 | 32 | 22 |
| | immersion | Material | Material | Material | Material | Material | Interfacial | Interfacial |
| | | breaking | breaking | breaking | breaking | breaking | peeling | peeling |
| | After fifth | 104 | 119 | 93 | 96 | 116 | 10 | 19 |
| | immersion | Material | Material | Material | Material | Material | Interfacial | Interfacial |
| | | breaking | breaking | breaking | breaking | breaking | peeling | peeling |

In the stacked polishing pad of each of Examples 1 to 5, interfacial peeling did not occur at the adhesive layer even after it was immersed in the polishing slurry at a high temperature for a long period of time. On the other hand, in the stacked polishing pad of each of Comparative Examples 1 and 2, the initial adhesive strength was low, and interfacial peeling occurred at the adhesive layer when it was immersed in the polishing slurry at a high temperature for a long period of time. These results indicate that laminated polishing pads produced with the hot-melt adhesive sheet of the invention can have stable polishing performance even at high temperature caused by polishing for a long period of time.

1. A hot-melt adhesive sheet for use in laminating a polishing layer and a support layer to form a stacked polishing pad, the hot-melt adhesive sheet comprising a hot-melt adhesive, wherein the hot-melt adhesive is a polyester-based hot-melt adhesive containing 100 parts by weight of a polyester resin as a base polymer and 2 to 10 pans by weight of an epoxy resin having two or more glycidyl groups per molecule.

2. The hot-melt adhesive sheet according to claim 1, wherein the polyester resin is a crystalline polyester resin.

3. The hot-melt adhesive sheet according to claim 1, wherein the polyester-based hot-melt adhesive has a melting point of 100 to 200° C. and a specific gravity of 1.1 to 13 and also has a melt flow index of 16 to 26 g/10 minutes under conditions of a temperature of 150° C. and a load of 2.16 kg.

4. The hot-melt adhesive sheet according to claim 1, which is a double-sided tape comprising: a backing whose both sides have been subjected to an adhesion-facilitating treatment; and adhesive layers provided on both sides of the backing, wherein the adhesive layers each comprise the hot-melt adhesive.

5. The hot-melt adhesive sheet according to claim 4, wherein the adhesion-facilitating treatment is a corona treatment or a plasma treatment.

6. An adhesive-layer-bearing support layer for a stacked polishing pad, comprising: a support layer; and an adhesive layer formed on one side of the support layer by applying a polyester-based hot-melt adhesive to one side of the support layer and curing the polyester-based hot-melt adhesive, wherein the polyester-based hot-melt adhesive contains 100 parts by weight of a polyester resin as a base polymer and 2 to 10 parts by weight of an epoxy resin having two or more glycidyl groups per molecule.

7. The adhesive-layer-bearing support layer according to claim 6, wherein the polyester resin is a crystalline polyester resin.

8. The adhesive-layer-bearing support layer according to claim 6, wherein the polyester-based hot-melt adhesive has a melting point of 100 to 200° C. and a specific gravity of 1.1 to 1.3 and also has a melt flow index of 16 to 26 g/10 minutes under conditions of a temperature of 150° C. and a load of 2.16 kg.

9. The adhesive-layer-bearing support layer according to claim 6, wherein the support layer is a polyurethane foam sheet having a skin layer on a side where the adhesive layer is formed.

10. The adhesive-layer-bearing support layer according to claim 9, wherein the polyurethane foam sheet is made from thermosetting polyurethane.
